(19) United States
(12) Patent Application Publication
(10) Pub. No.: US 2025/0229345 A1
(43) Pub. Date: Jul. 17, 2025

(54) ROTARY CUTTING TOOL, SUCH AS A DRILL OR A REAMER

(71) Applicant: Desgranges Outils Coupants, Andrézieux-Bouthéon (FR)

(72) Inventors: Ludovic VERMOREL, Poncins (FR); Tsiory RAKOTOMALALA-BONNEFOI, Saint Etienne (FR)

(73) Assignee: Desgranges Outils Coupants, Andrézieux-Bouthéon (FR)

(21) Appl. No.: 19/095,055

(22) Filed: Mar. 31, 2025

Related U.S. Application Data
(63) Continuation of application No. 17/598,493, filed on Sep. 27, 2021.

(30) Foreign Application Priority Data
Mar. 28, 2019 (FR) FR1903291

(51) Int. Cl. B23B 51/10; B23D 77/00

(52) U.S. Cl. CPC B23B 51/104; B23D 77/00; B23B 2251/04; B23B 2251/122

(57) ABSTRACT

The invention relates to a rotary cutting tool (1), such as a drill (2) or a reamer (3), extending longitudinally along an axis (4) and comprising at least one main cutting edge (5) so that when the tool (1) is rotated about the axis (4), the tool (1) advances axially to perform a cutting operation on a material.

According to the invention, the tool (1) comprises means for braking (7) the axial advance of the tool (1) during the cutting operation.

### RELATED APPLICATIONS

This application is a Continuation U.S. patent application Ser. No. 17/598,493 filed on Sep. 27, 2021, which which is a National Phase of PCT Patent Application No. PCT/EP2020/058431 having International filing date of Mar. 25, 2020, which claims the benefit of priority of France Patent Application No. FR1903291 filed on Mar. 28, 2019. The contents of the above applications are all incorporated by reference as if fully set forth herein in their entirety.

### FIELD AND BACKGROUND OF THE INVENTION

The invention relates to the technical fields of rotary cutting tools, e.g. helical tools, for carrying out drilling, boring, reaming, countersinking or chamfering operations by rotation.

The invention relates in particular to drilling drills, right-handed helical reamers, reaming drills, countersinks or chamfering milling cutters (milling cutter), and finds an advantageous application in the field of aeronautics, where the assembly of aircraft structures requires the drilling and reaming of a considerable number of holes, in parts which may be made up of a stack of a plurality of layers, sometimes of different materials

Known in the prior art are helical drilling tools, such as drills or right-handed helix reamers, which include at least one main cutting edge and extend longitudinally along an axis. These tools are intended to be rotated about the axis and advanced axially to perform a drilling operation on a material.

This type of tool can also be stepped or driven when large diameters need to be drilled in particularly hard materials such as steel or titanium, for example, or when tight bore tolerances need to be achieved, or when the assembly process of the parts to be drilled requires pilot holes.

The problem with this type of rotary drilling tool lies in the effect of the tool's engagement with the material during drilling, which can be relatively high, leading to the risk of blocking or breaking the tool.

This problem is all the more exacerbated when the drilling operation is manual. Indeed, the operator has difficulty controlling the feed of the tool into the drilled material and must hold the tool to oppose the engagement force of the tool.

In addition, when the tool is stepped, there are also problems with jerks in the tool steps that impact the material, further increasing the risk of jamming or breakage.

To avoid the risk of jamming or breakage, it is known to produce tools with an intrinsically low force of engagement in the material, in this case by reducing the helix angle and/or by reducing the clearance angle of the cutting edges. This has the disadvantage of increasing the thrust forces, making these manual operations time-consuming and tedious, with a consequent reduction in the service life of the tools.

### SUMMARY OF THE INVENTION

One of the purposes of the invention is therefore to remedy the above-mentioned disadvantages by providing a rotary cutting tool, for example helical, such as a drill, a reamer, a right-handed helix reamer, or else with a cutting angle generated by a slope, such as a sanding or chamfering cutter, whose risks of blocking or breaking during a cutting operation, and in particular manual drilling, are avoided.

Another objective of the present invention is to provide such a tool which allows an optimal drilling rate by reducing the cycle times of the drilling operations.

Another objective of the invention is to provide such a tool that allows for a reduction in pushing forces, an increase in the life of these tools, and an improvement in drilling comfort and hole quality.

To this end, a rotary cutting tool has been developed which is in accordance with the state of the art in that it extends longitudinally along an axis and has at least one main cutting edge so that when the tool is rotated about the axis, the tool advances axially to perform a cutting operation on a material.

According to the invention, the tool comprises means for braking the axial advance of the tool during the cutting operation.

Thus, the braking means included in the rotary tool make it possible to limit the effect of significant engagement of this type of tool in the drilled material, so that the user is better able to control the feed of said tool during manual drilling. As a result, the risk of jamming or breakage is avoided.

Furthermore, tool geometries with greater intrinsic engagement can be employed in combination with these braking means, thereby reducing pushing forces and cycle time, while avoiding the risks of jamming.

According to a particular embodiment, the braking means are positioned axially set back with respect to the main cutting edge and are intended to come into contact with the drilled material during the drilling operation in order to slow down the axial advance of the tool.

According to a particular embodiment, the braking means are in the form of an additional cutting edge located downstream of the main cutting edge with respect to the rotation of the tool, and having a lower cutting power than the main cutting edge.

For this purpose, the additional cutting edge has:
an axial cutting angle that is smaller than the axial cutting angle of the main cutting edge;
   and/or
a clearance angle less than the clearance angle of the main cutting edge.

Other techniques are possible. For example, the additional cutting edge comprises an edge preparation, such as a so-called honing radius, i.e., the additional cutting edge is rounded and has a circular cross-section, or a facet.

In this way, the additional cutting edge has a lower cutting power than the main cutting edge, thus limiting the penetration of the additional cutting edge into the material, which makes it possible to control the feed of the tool when drilling manually, or even when drilling automatically or semi-automatically with column drills, semi-automatic machines, Automatic Drilling Units or even on numerical control.

The invention also allows the axial cutting angle and clearance angle of the main cutting edge to be increased, thereby increasing the cutting power and efficiency of the tool.

According to another particular embodiment, the braking means is in the form of a braking surface or braking edge, positioned downstream of the main cutting edge with respect to the rotation of the tool.

The braking surface is, for example, constituted by a secondary clearance extending a main clearance of the main cutting edge, the angle of the secondary clearance being smaller than the angle of the main clearance.

The braking edge is, for example, constituted by a trailing edge of a clearance of the main cutting edge set back from the main cutting edge, and which is not located in the generatrix of the clearance.

According to particular embodiments, the braking means are positioned axially set back from the main cutting edge by a distance between 5 μm and 250 μm, and preferably between 5 μm and 200 μm.

The rotary cutting tool according to the present invention may be in the form of a drill, a reamer, a right-handed helix reamer, a sinking or chamfering cutter, and preferably comprises braking means on a tip or on an entry chamfer or, in the case of a stepped tool, on at least one step, so that the effects of jerks, during manual drilling, are eliminated.

### BRIEF DESCRIPTION OF THE SEVERAL VIEWS OF THE DRAWINGS

Other advantages and characteristics of the invention will become clearer from the following description, given by way of non-limiting example, from the attached figures in which:

FIG. 1 is a representation showing a stepped or piloted drill bit according to the invention;

FIG. 2 is a representation showing a right-handed helix reamer or reamer-drill, stepped or piloted, according to the invention;

FIG. 3 is a representation showing a main cutting edge and an additional cutting edge of the same drill, the additional cutting edge being axially set back and with a smaller axial cutting angle than the main cutting edge;

FIG. 4 is a representation showing a main cutting edge and an additional cutting edge of the same drill, the additional cutting edge being axially set back and with a smaller clearance angle than the main cutting edge;

FIG. 5 is a representation showing a main cutting edge and an additional cutting edge of the same double flute drill, the additional cutting edge being axially set back and with a smaller clearance angle than the main cutting edge;

FIG. 6 is a representation showing a main cutting edge of a drill with a secondary clearance extending a main clearance, the angle of the secondary clearance smaller than the angle of the main clearance, and axially set back;

FIG. 7 is a representation showing a trailing edge of a clearance of the main cutting edge set back from the main cutting edge to form a braking edge;

FIG. 8 is an illustration of an additional cutting edge of a drill with a honing radius;

FIG. 9 is a representation showing an additional cutting edge of a drill with a facet.

### DESCRIPTION OF SPECIFIC EMBODIMENTS OF THE INVENTION

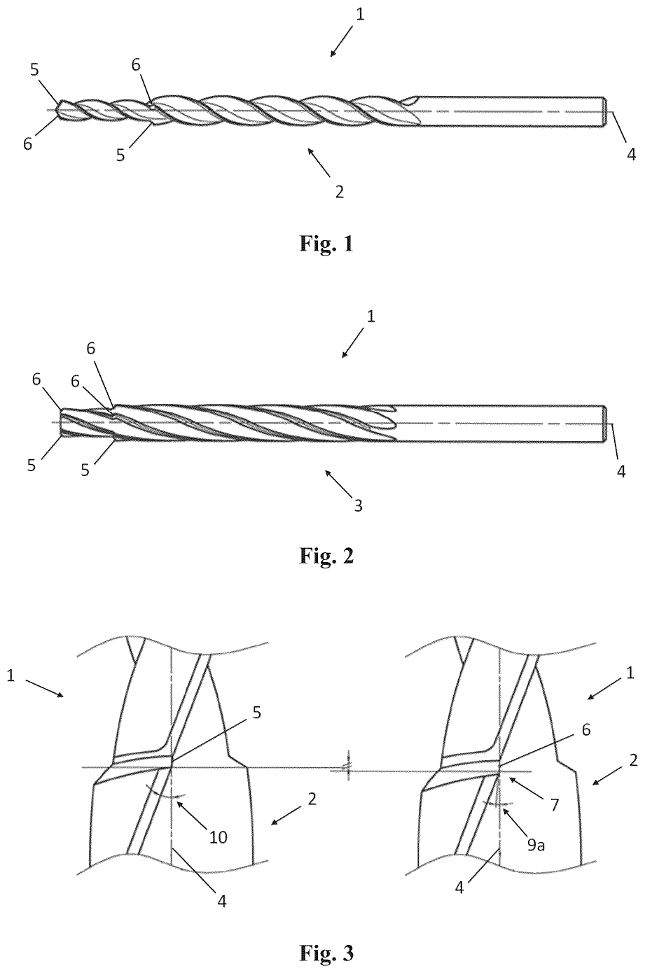

With reference to FIGS. 1 to 9, the invention relates to a rotary tool (1) for performing drilling or reaming operations, and in particular relates to a rotary cutting tool (1) such as a drill (2), a right-handed helix reamer (3), a sanding cutter or chamfering cutters, etc.

In a known manner, and with reference to FIGS. 1 and 2, the tool (1) extends longitudinally along an axis (4) and has at least one main cutting edge (5), and preferably at least one additional cutting edge (6), opposite or not, so that when the tool (1) is rotated about the axis (4), the tool (1) advances axially to perform the actual drilling operation.

Depending on the application, and in particular on the hardness of the material to be drilled, the drill (2) or reamer (3) can be stepped or piloted, and with a single or double flute, see FIG. 5.

Indeed, the tool (1) according to the invention finds an advantageous application in particular in the field of aeronautics, where a relatively large number of holes must be drilled to assemble parts together, sometimes requiring the drilling of multilayer parts, possibly of different materials.

Thus, to facilitate the operation of drilling holes of relatively large diameter, the drill (2) or reamer (3) with a right-handed helix has several stages whose diameters increase successively.

In this application, the right-handed helix drills (2) or reamers (3) are heavily used and, given the high torque required to drill hard materials such as steel or titanium, and the relatively large diameters, the right-handed helix drill (2) or reamer (3) tends to have a very high engagement effect, generated by the slope of the cutting angle or the helical shape of the tool (1).

This engagement effect is restrictive when manual drilling is involved, as the operator has difficulty controlling the feed of the tool (1), which leads to the risk of breakage or blocking of the tool (1). Furthermore, when the tool (1) is stepped, these risks are increased because the tool (1) is jerked against the drilled material at each step.

The tool (1) according to the invention therefore comprises means (7) for braking the axial advance of the tool (1) during the drilling operation.

For this purpose, and according to a particular embodiment, the braking means (7) are positioned axially set back with respect to the main cutting edge (5) and are intended to come into contact with the drilled material during the drilling operation in order to slow down the axial advance of the tool (1).

These braking means (7) may, for example, be either in the form of an additional cutting edge (6), or in the form of a braking surface (8), or in the form of a braking edge (9).

With reference to FIGS. 3 to 5, 8 and 9, and in the case of an additional cutting edge (6), it is located downstream of the main cutting edge (5) with respect to the rotation of the tool (1), and, in order to contact the drilled material and slow down the feed, it has a lower cutting power than the main cutting edge (5).

The fact that the additional cutting edge (6) has a lower cutting power limits the entry into the material of said additional cutting edge (6), which makes it possible to control the feed rate in drilling, especially manual drilling.

To decrease the cutting power of the additional cutting edge (6), several techniques are possible.

For example, with reference to FIG. 3, the additional cutting edge (6) has a smaller axial cutting angle (9a) than the axial cutting angle (10) of the main cutting edge (5). For example, for a drill with a main cutting edge (5) and a single opposing cutting edge, the axial cutting angle (10) of the main cutting edge (5) may be 30°, while the axial cutting angle (9a) of the additional cutting edge (6) may be 20° or even negative.

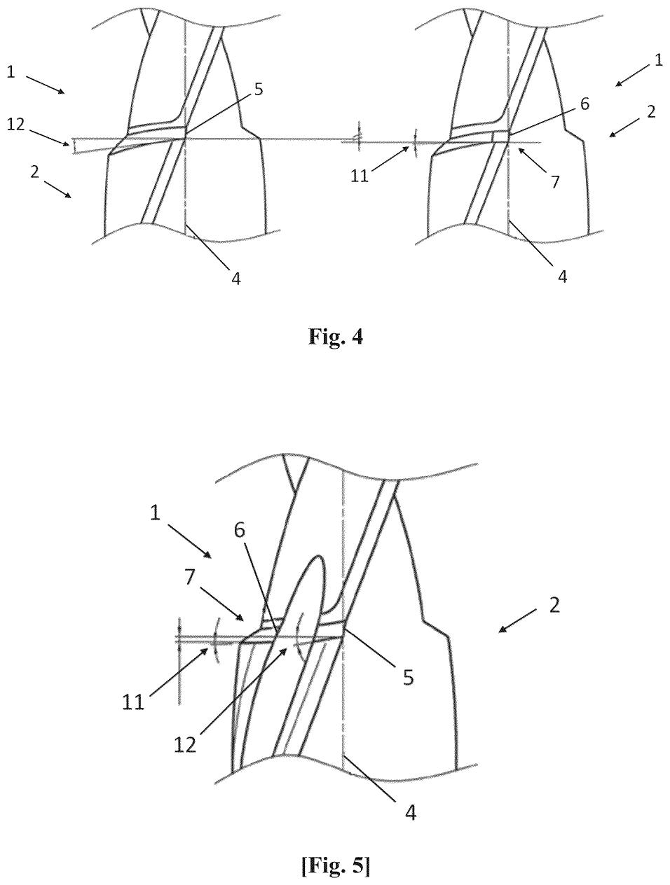

According to another embodiment, and with reference to FIGS. 4 and 5, the additional cutting edge (6) has a clearance angle (11) smaller than the clearance angle (12) of the main cutting edge (5). As an example, the clearance angle (12) of the main cutting edge (5) is for example between 8° and 12°, while the clearance angle (11) of the additional cutting edge (6) is for example 1°.

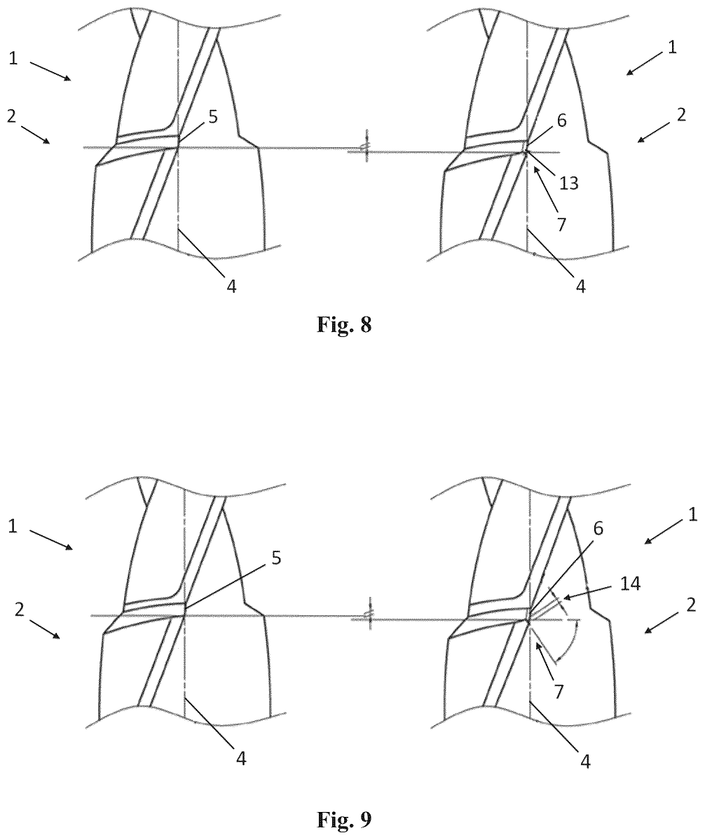

Other ways to reduce the cutting power of the additional cutting edge (6) are to make a so-called honing radius (13) at the additional cutting edge (6) with a radius of more than 8 μm, for example 10 μm, see FIG. 8, or to make a facet (14) or to chamfer said additional cutting edge (6), see FIG. 9. The facet (14) can for example have a width of more than 10 μm. In the latter configuration, the result is similar to the arrangement of an additional cutting edge (6) with a smaller cutting angle and/or clearance than the main cutting edge (5), except that the dimensions are reduced.

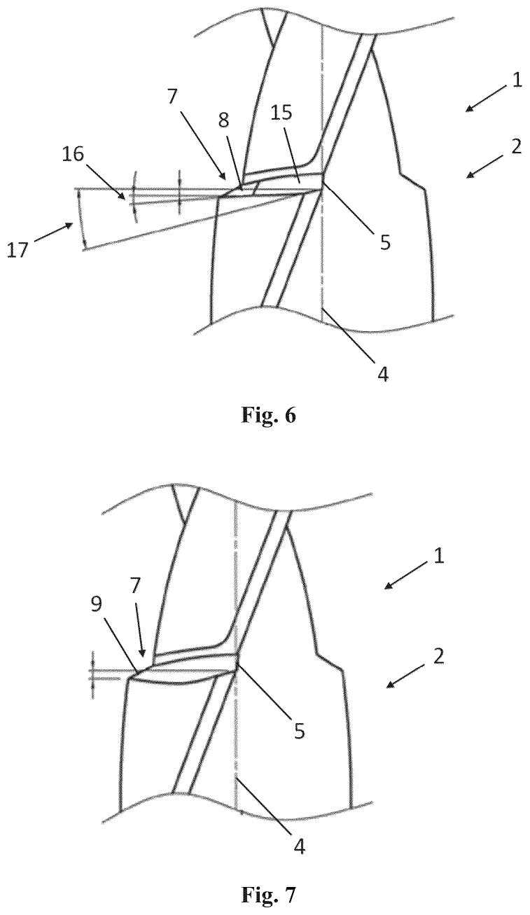

With reference to FIG. 6, and when it is a braking surface (8), it is for example constituted by a secondary clearance extending a main clearance (15) of the main cutting edge (5). The angle (16) of the secondary clearance is smaller than the angle (17) of the main clearance (15) so that the braking surface (8) formed by the secondary clearance comes into contact with the drilled material to slow down the advance of the tool (1). For example, the angle (17) of the main clearance (15) is between 8° and 12°, while the angle (16) of the secondary clearance is 1° or even negative. In the case of a secondary clearance with a negative angle, braking is achieved by a braking edge (9), constituted by the trailing edge of the said secondary clearance, see FIG. 7.

With reference to FIG. 7, and when it is a braking edge (9), it is in fact constituted by a trailing edge of a clearance of the main cutting edge (5) set back with respect to the main cutting edge (5), and which is not located in the generatrix of the clearance.

The braking means (7) are preferably set back axially by a distance of between 5 μm and 250 μm, and preferably between 5 μm and 200 μm, from the main cutting edge (5), depending on the spacing in the tool's path of rotation (1) between the main cutting edge (5) and the braking means (7). For a drill with a main cutting edge (5) and braking means (7) positioned on an opposite additional cutting edge (6), an axial distance of less than 5 μm would tend to lengthen the cycle times of the tool (1) and shorten its life, while an axial distance of more than 250 μm would lead to the risk of blocking or breaking the tool (1) during the drilling operation.

The braking means (7) can be located directly on the tip of a drill bit, on the entry chamfer of the tool, or on one or each stage if necessary.

Another way of presenting the tool according to the invention is to consider that the braking means are set back from the main cutting edge (5) and comprise a clearance (11, 16) having a smaller angle than the clearance angle (12, 17) of the main cutting edge (5), or even a negative angle, so as to generate an edge, cutting or not depending on its position with respect to the flutes, intended to come into contact with the drilled material during the cutting operation in order to slow down the axial advance of the tool (1).

The geometry of the tool thus obtained has intrinsic contradictory properties, since the main edge, with its axial cut and clearance value, helps the tool advance in the material, while the axially set back edge, generated by a clearance angle smaller than that of the main cutting edge, will limit the advance. The maximum feed rate of the tool (1) will be determined by the angular and axial position (i.e. helical offset) of this edge in contact with the material.

According to one embodiment, the clearance for generating the axially set back edge intended to come into contact with the drilled material during the cutting operation to slow down the axial advance of the tool is a clearance (11) of an additional cutting edge (6) located downstream of the main cutting edge (5) with respect to the rotation of the tool (1), and having a lower cutting power than the main cutting edge (5).

According to another example, the clearance allowing to generate the axially set back edge and intended to come into contact with the drilled material during the cutting operation in order to slow down the axial advance of the tool is a secondary clearance (16) in the extension of a main clearance (15) of the main cutting edge (5) so as to constitute either a braking surface (8) positioned downstream of the main cutting edge (5) with respect to the rotation of the tool (1) in the case of a secondary clearance (16) with an angle smaller than the angle (17) of the main clearance (15), or a braking edge (9) constituted by the trailing edge of said secondary clearance (16) in the case of a secondary clearance (16) with an angle smaller than the angle (17) of the main clearance (15) and negative.

It is clear from the above that the invention provides a rotary cutting tool (1) in which the risks of blockage or breakage during drilling, and in particular manual drilling, are avoided, while allowing an optimum drilling rate by reducing the cycle times of the drilling operations, and allowing the pushing efforts to be reduced, increasing the life of these tools, and improving the drilling comfort and the quality of the holes.

1. A rotary cutting tool extending longitudinally along an axis and having:
at least one main cutting edge configured to rotate about the axis while the rotary cutting tool advances axially to perform a cutting operation on a material,
an additional cutting edge positioned axially set back with respect to the main cutting edge and located downstream of the main cutting edge with respect to the rotation of the rotary cutting tool,
wherein the additional cutting edge has a lower cutting power than the main cutting edge and is configured to contact the material during the cutting operation to brake the axial advance of the rotary cutting tool,
wherein the additional cutting edge has a smaller clearance angle (11) than the clearance angle (12) of the main cutting edge.

2. The rotary cutting tool according to claim 1, wherein the additional cutting edge is positioned axially set back by a distance of between 5 μm and 200 μm.

3. The rotary cutting tool according to claim 1, wherein the rotary cutting tool is in the form of one of:
a drill bit,
a reamer with a right-handed helix,
a reamer,
a sanding cutter and
a chamfering cutter.

4. The rotary cutting tool according to claim 1, wherein the additional cutting edge is on a tip or on an entry chamfer or, in the case of a stepped tool, on at least one step.
